(19) United States
(12) Patent Application Publication
(10) Pub. No.: US 2005/0075787 A1
(43) Pub. Date: Apr. 7, 2005

(54) Display system and method of electronic map

(76) Inventor: Wen-Pei Chou, Concord, CA (US)

Correspondence Address: HARNESS, DICKEY & PIERCE, P.L.C., P.O. BOX 8910, RESTON, VA, 20195, US

(21) Appl. No.: 10/947,219

(22) Filed: Sep. 23, 2004

(30) Foreign Application Priority Data
Sep. 23, 2003 (TW) 92217101

(51) Int. Cl. G01C 21/36

(52) U.S. Cl. 701/208

(57) ABSTRACT

An electronic map display system is provided. The system includes a positioning system for positioning an object and providing a coordinate of the object; a communication system for transmitting the coordinate; a server for receiving the coordinate from the communication system, providing a geographic information in response to the coordinate, and transmitting the coordinate and the geographic information; and a client interface for receiving the coordinate and the geographic information from the communication system and displaying an electronic map based on an equation predetermined by a design standard.

### FIELD OF THE INVENTION

The present invention relates to a display system and method of an electronic map, and more specifically to the application of integrating Global Positioning System (GPS), Global Positioning System (GPS), and the geographical information system to display a real-time and dynamic electronic map.

### BACKGROUND OF THE INVENTION

The rudiment and development of the geographical information system (GIS) can be traced back to the 1960s'. People attribute the emergence of the geographical information system to: (1) the improvement of the map-making technology; (2) the fast development of the digital computer; and (3) the innovation of the technology of space analyzing.

The main point of the GIS research in 1960s' is how to use the traditional number value method to deal with the technological problem that the figure materials cause while we use a map which is set in a low speed, small capacity, and difficult to use computer.

In those years, most researches and developments are all done by the government departments, not the schools which neither do any commercial suit software. Among these systems, adopting the network system, researched and developed by the school, the most famous is SYMAP, made by Harvard University. However, these systems have not existed anymore until today. The only exception is the system of Minnesota State of U.S.A., which is still operating today.

In 1963, the first meeting about Urban Planning Information Systems and Programs was held. This meeting has contributed to the foundation of Urban and Regional Information Systems Association, URISA.

By 1970s', the western countries began to generally realize the question of the environment and land which were utilized. They thought that the various kinds of geographical information must be collected and analyzed immediately and efficiently.

At the same time, the computer technology has also proceeded greatly. Users can talk to each other interactively by computers. The price of the input and output equipments was reduced rapidly, which makes it possible that one needs GIS is able to set up hiss own GIS system. Meanwhile, the schools, the research units began to invest lots of time and money to the research and development of this field, too.

In 1970, International Geographical Union (IGU) held the first meeting about GIS in Ottawa of Canada (Ottawa). The number of the participants was only 40. However, in 1972 when the second was held, it increased to 300.

In this period, the relevant systems and software were made in a large amount. However, the researches and developments were mostly repeated, and almost had little innovation. The schools also trained more relevant talents gradually.

The commercial company also began to develop and sell the software that can be used directly. Certainly, it led to the births of a lot of little databases too. However they could not be operated compatibly each other. This problem was not be dealt with seriously because GIS was not big enough at that time.

In 1980s', the demands for GIS rose continuously. Meanwhile, the information that GIS dealt with were no longer confined to one area or one country, but the application that crossed over national boundaries. For example, the research about the anti-desertification that the United Nations carried in north Africa covered the entire north African.

There was a magnificent advance in computer technologies. The speed, capacity, and I/O equipments, had a considerable progress than before, which all promoted the availability of GIS.

In the countries of small lands, the type that the land utilized has the trend towards the intensive form of the spot type. If the government has not made proper rule to manage the land, the utilizing type of the land will be in chaos and the quality of the environment will be bad. However, the land management of the government must be considered synthetically according to the condition of the local natural environment, the positions of the communal facilities, the land utilizing type, and the development trend of the future. In other words, the demands of land management have played a quite important role in the development of GIS system.

At present, the applications of GIS still remain in the field of the government and the public utilities. In the application of the government, the most famous is the ground policy information management system and the territory information system.

However, it is difficult to use such material system in a real-time dynamic 3D electronic map. Because the download speed of all kinds of communications such as CDPD, Data Tac, GSM, GPRS, and 3G is limited. When the data stored in the information system is transformed to a dynamic 3D electronic map, the data will be too huge to handle. They also take more time (sometimes as long as several minutes) to finish the download. Therefore, it is absolutely not suitable for the application of the dynamic 3D electronic map.

### SUMMARY OF THE INVENTION

It is the main object of the present invention to provide an electronic map display system and method, which displays an electronic map of an object based on an equation predetermined by a design standard. The system and the method can simplify the information of the electronic map and decrease the data of the electronic map.

According to the main object of the present invention, the electronic map display system includes a positioning system for positioning an object and providing a coordinate of the object; a communication system for transmitting the coordinate; a server for receiving the coordinate from the communication system, providing a geographic information in response to the coordinate, and transmitting the coordinate and the geographic information; and a client interface for receiving the coordinate and the geographic information from the communication system and displaying an electronic map based on an equation predetermined by a design standard.

According to the main object of the present invention, the electronic map display system includes a positioning system for positioning an object and providing a coordinate of the object; a communication system for transmitting the coordinate; and a server for receiving the coordinate from the communication system and displaying an electronic map based on an equation predetermined by a design standard according to the coordinate and a geographic information of the coordinate.

According to another object of the present invention, the electronic map display method steps of providing a coordinate of an object; and displaying an electronic map based on an equation predetermined by a design standard according to the coordinate and a geographic information of the coordinate.

Preferably, the object includes a client interface.

Preferably, the client interface includes a display for displaying the electronic map.

Preferably, the communication system is one selected from a group consisting of a Cellular Digital Packet Data (CDPD), a Data Tac, a Global Sim Mobile (GSM), a General Packet Radio Service (GPRS), and a Third Generation Mobile Terminal (3G Terminal).

Preferably, the positioning system is a Global Positioning System (GPS).

Preferably, the design standard is a design standard for a road routing.

Preferably, the design standard is a design standard for a building.

Preferably, the electronic map shows a route and its surroundings of a road.

Preferably, the electronic map is a real-time and dynamic electronic map.

The above objects and advantages of the present invention will become more readily apparent to those ordinarily skilled in the art after reviewing the following detailed descriptions and accompanying drawings, in which:

### BRIEF DESCRIPTION OF THE DRAWINGS

The patent or application file contains at least one drawing executed in color. Copies of this patent or patent application publication with color drawing will be provided by the Office upon request and payment of the necessary fee.

FIG. 1 is a schematic diagram of the preferred embodiment of the electronic map display system in accordance with the present invention; and

FIG. 2 is an actual illustration of the preferred embodiment of the electronic map in accordance with the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

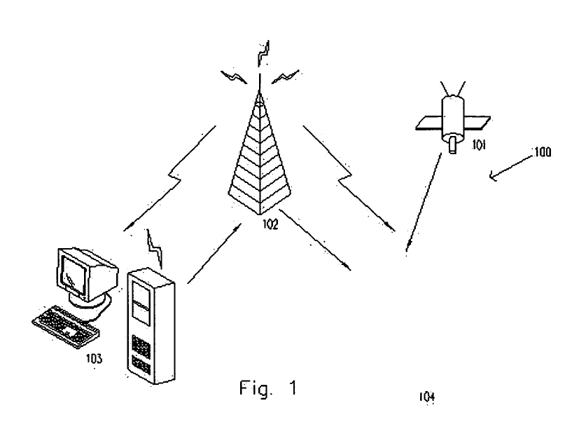

Please refer to FIG. 1, which shows a schematic diagram of the preferred embodiment of the electronic map display system in accordance with the present invention. The electronic map display system 100 includes a positioning system 101, a communication system 102, a server 103, and a client surface (inside the truck 104). The positioning system 101 can be a Global Positioning System (GPS). The Global Positioning System 101 is for positioning an object, the truck 104, and providing a coordinate of the truck 104 while the truck 104 is moving to any place of the world.

The communication system 102 is for transmitting the coordinate of the truck 104. The communication system 102 can be a Cellular Digital Packet Data (CDPD), a Data Tac, a Global Sim Mobile (GSM), a General Packet Radio Service (GPRS), or a Third Generation Mobile Terminal (3G Terminal).

The server 103 includes a geographical information system. When the server 103 receives the coordinate from the communication system 102, the server 103 provides a geographical information from the geographical information system in response to the coordinate and transmits the coordinate and the geographical information.

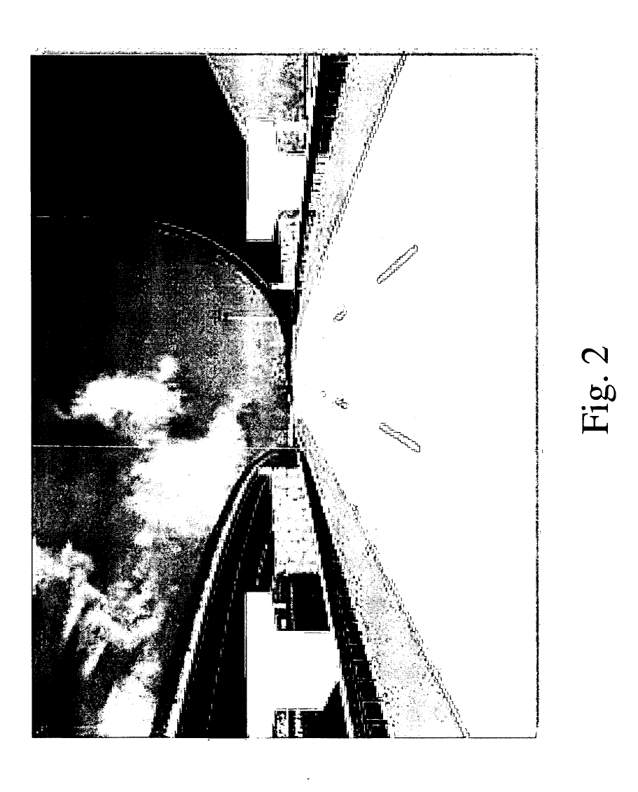

After the client interface inside the truck 104 receives the coordinate and the geographic information from the communication system 102, a display included in the client interface displays an electronic map as FIG. 2 shows, which is based on an equation predetermined by a design standard. The design standard is for a road routing or a building so that the electronic map shows a route and its surroundings of the road where the truck 104 is.

All design standards follows the rules of engineering design, so the design standard can be performed in a proper equation. Therefore, with the coordinate and the basic geographic information, or the information of road routes and architectures, the electronic map which shows where the object is will be obtained easily. The system 100 can simplify the information of the electronic map and decrease the data of the electronic map. The system 100 makes a real-time and dynamic electronic map without being limited to the bandwidth of the wireless transmission.

The present invention provides a display system and method of an electronic map in the application of integrating Global Positioning System (GPS), Global Positioning System (GPS), and the geographical information system to display a real-time and dynamic electronic map based on an equation predetermined by a design standard.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

1. An electronic map display system, comprising:
a positioning system for positioning an object and providing a coordinate of said object;
a communication system for transmitting said coordinate;
a server for receiving said coordinate from said communication system, providing a geographic information in response to said coordinate, and transmitting said coordinate and said geographic information; and
a client interface for receiving said coordinate and said geographic information from said communication system and displaying an electronic map based on an equation predetermined by a design standard.

2. The electronic map display system according to claim 1, wherein said client interface comprises a display for displaying said electronic map.

3. The electronic map display system according to claim 1, wherein said communication system is one selected from a group consisting of a Cellular Digital Packet Data (CDPD), a Data Tac, a Global Sim Mobile (GSM), a General Packet Radio Service (GPRS), and a Third Generation Mobile Terminal (3G Terminal).

4. The electronic map display system according to claim 1, wherein said positioning system is a Global Positioning System (GPS).

5. The electronic map display system according to claim 1, wherein said design standard is a design standard for a road routing.

6. The electronic map display system according to claim 1, wherein said design standard is a design standard for a building.

7. The electronic map display system according to claim 1, wherein said electronic map shows a route and its surroundings of a road.

8. The electronic map display system according to claim 1, wherein said electronic map is a real-time and dynamic electronic map.

9. An electronic map display system, comprising:
a positioning system for positioning an object and providing a coordinate of said object;
a communication system for transmitting said coordinate; and
a server for receiving said coordinate from said communication system and displaying an electronic map based on an equation predetermined by a design standard according to said coordinate and a geographic information of said coordinate.

10. The electronic map display system according to claim 9, wherein said object comprises a client interface.

11. The electronic map display system according to claim 10, wherein said client interface comprises a display for displaying said electronic map.

12. The electronic map display system according to claim 9, wherein said communication system is one selected from a group consisting of a Cellular Digital Packet Data (CDPD), a Data Tac, a Global Sim Mobile (GSM), a General Packet Radio Service (GPRS), and a Third Generation Mobile Terminal (3G Terminal).

13. The electronic map display system according to claim 9, wherein said positioning system is a Global Positioning System (GPS).

14. The electronic map display system according to claim 9, wherein said design standard is a design standard for a road routing.

15. The electronic map display system according to claim 9, wherein said design standard is a design standard for a building.

16. The electronic map display system according to claim 9, wherein said electronic map shows a route and its surroundings of a road.

17. The electronic map display system according to claim 9, wherein said electronic map is a real-time and dynamic electronic map.

18. A electronic map display method, comprising steps of:
providing a coordinate of an object; and
displaying an electronic map based on an equation predetermined by a design standard according to said coordinate and a geographic information of said coordinate.

19. The electronic map display method according to claim 18, wherein said design standard is a design standard for a road routing.

20. The electronic map display method according to claim 18, wherein said design standard is a design standard for a building.
